(19) United States
(12) Patent Application Publication
(10) Pub. No.: US 2010/0304784 A1
(43) Pub. Date: Dec. 2, 2010

(54) System and Method for Placing a Mobile Telephone Call on a Secondary Network

(76) Inventors: Hua Lin, Shanghai (CN); Ping Mao, Beijing (CN); Yunhai Xie, Beijing (CN)

Correspondence Address: CLIFFORD H. KRAFT, 320 ROBIN HILL DR., NAPERVILLE, IL, 60540, US

(21) Appl. No.: 12/474,726

(22) Filed: May 29, 2009

(51) Int. Cl. H04M 1/00

(52) U.S. Cl. 455/552.1

(57) ABSTRACT

A system and method for placing cellular toll calls over a secondary network to allow a subscriber to save money or realize some other advantage. Either a small software package can be downloaded to a mobile user's telephone to act as an interface into the service or the internet can be used with a wireless application protocol (WAP) using a WAP browser on the mobile telephone. A manager station operated by a third party (generally not the cellular network owner nor the secondary network owner) can receive request calls for cellular users to place toll calls. In a particular embodiment, the software in the user's mobile telephone can transmit the number desired to be called via a mobile data service like GPRS or WAP over GPRS to the manager station. Any method of transmitting this number is within the scope of the present invention including a direct mobile telephone call to the manager station. The manager station can then place two outgoing calls over the secondary network, the first to the called number, and the second a callback to the originating mobile telephone. The called number can be either a mobile or fixed station. When each of the two outgoing calls is set up, the manager can connect or conference the two calls together. The number of calls is not limited to two. After the calls are connected, the manager can track of billing for the service using methods known in the art.

### BACKGROUND

1. Field of the Invention

The present invention relates generally to providing telephone service and more particularly to a system and method for placing a mobile call on a secondary network rather than over the mobile network.

2. Description of the Prior Art

It is well known in the art to place a mobile telephone call to another telephone using commercially available cellular services. Cellular telephone networks operate using well-known principles with systems of base stations and access into landline public switched telephone network PSTN services.

In some systems, it is cheaper to place a toll call (long distance) or other call over an alternate network (such as a PSTN or other secondary network) between two points than a cellular call between the same two points. In particular, it might be cheaper to place a toll call between two mobile stations or between a mobile station and a fixed station if a third party station were to initiate outgoing calls to each of the two end stations using the secondary network then for one of the end stations to directly call the other. In this case, the third party or “Manager” station could connect the two calls after they are set up in a manner similar to a conference.

It would be advantageous to have a service that could take advantage of the price difference where a cellular subscriber could have cheaper secondary network calls placed for him by a third party station when he desires to make a mobile toll call.

### SUMMARY OF THE INVENTION

The present invention relates to placing cellular calls over a secondary network to allow a subscriber to save money or enjoy some other advantage. Either a small software package can be downloaded to a mobile user's telephone to act as an interface into the service or the internet can be used with a wireless application protocol (WAP) using a WAP browser on the mobile telephone. A manager station operated by a third party (generally not the cellular network owner or the secondary network owner) can receive request calls for cellular users to place toll calls. In a particular embodiment, the software in the user's mobile telephone can transmit the number desired to be called via a mobile data service like GPRS, WAP over GPRS (or other data service) to the manager station. Any method of transmitting this number is within the scope of the present invention including a direct mobile telephone call to the manager station. The manager station can then place two outgoing calls over a secondary network, the first to the called number, and the second a callback to the originating mobile telephone. The called number can be either a mobile or fixed station. When each of the two outgoing calls is set up, the manager can connect or conference the two calls together. Any method of connecting or conferencing two or more calls is within the scope of the present invention. The number of calls is not limited to two. It is within the scope of the present invention to connect or conference any number of locations in the manner described. After the calls are connected, the manager can track of billing for the service using methods known in the art.

### DESCRIPTION OF THE FIGURES

Attention is directed to several illustrations to aid in understanding the principles of the present invention:

FIG. 1A is a diagram of an initial call request by a mobile subscriber.

FIG. 1B is a diagram of the call that is set up for the user of FIG. 1A.

FIG. 2 is an overall system diagram of an embodiment of the present invention sufficient to place calls.

FIG. 3 is an overall system diagram of a system capable of servicing multiple mobile subscribers.

FIG. 4 shows an embodiment of a mobile screen ready to place a call.

Several drawings and illustrations have been presented to explain the present invention. The scope of the present invention is not limited to what is shown in the figures.

### DESCRIPTION OF THE INVENTION

The present invention relates to a system and method for placing calls from mobile stations over a secondary network when that is cheaper, or there is some other advantage in doing this rather than simply placing mobile calls. A secondary network could be a landline such as a PSTN, a TDM network, another mobile network, the internet voice over IP, Session Initiated Protocol (SIP) or any other type of network capable of carrying voice traffic. In this system, a small software package can be downloaded into a subscriber's mobile telephone. This package can be written in Java, C++ or any other programming language. This package should be compatible with the mobile operating systems commonly in use. When the subscriber wishes to place a mobile call using the service, the software package asks the subscriber to enter a desired called telephone number. This target number along with a call setup request containing an ID of the subscriber telephone is transmitted to a third party manager station. If the subscriber has a valid account, call setup can begin. The call setup request including the target number and basic subscriber information can be transmitted between the mobile telephone and the third party manager station via the internet using a mobile data service such as GPRS. It should be noted that any mobile data service can be used as well as a direct cellular call to the manager station. Any method of transmitting setup information including the target number is within the scope of the present invention. The use of a data service such as GPRS is particularly attractive because of the relatively fixed cost to use this service. The manager station can be geographically remote from the mobile station and still provide the service without incurring higher costs.

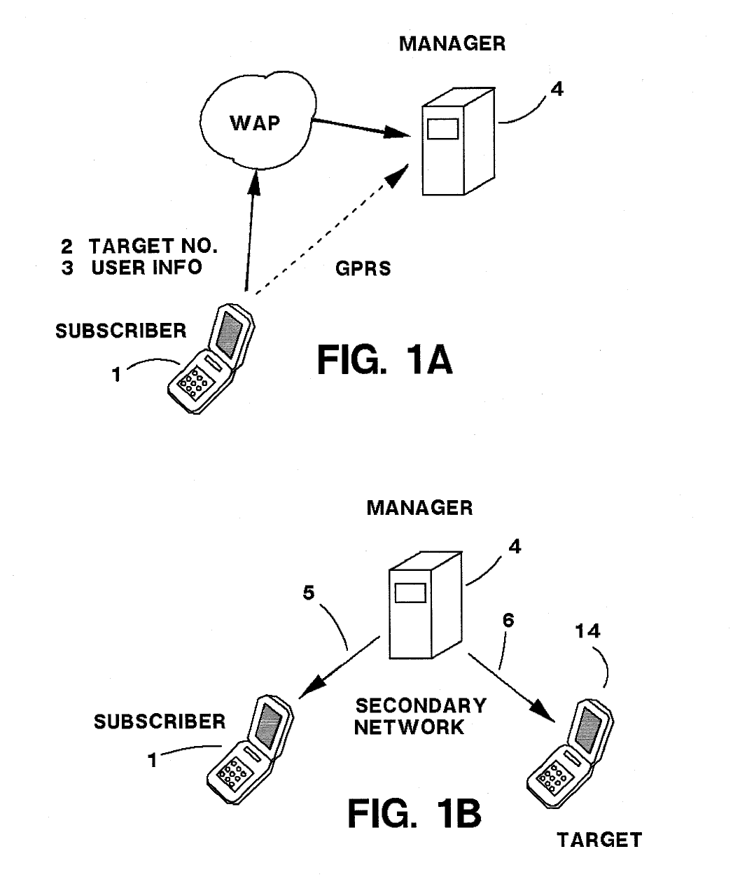

FIG. 1A shows a diagram of this part of the call setup. The mobile telephone 1 brings up a particular menu item to the user where the user enters the desired target number. This menu can either appear from software previously downloaded to the telephone, or it can appear on the user's WAP browser. The mobile phone then transmits the target telephone number or SIP address 2 and user information 3 over a mobile packet data service such as GPRS into the internet. The manager station 4 which can be geographically remote from the mobile 1 receives the information, checks the subscriber's account and begins a call set up process. The user's correct telephone number may be used, or a virtual number owned by the user may be substituted and received as the caller ID.

FIG. 1 B shows the set up call. The manager station 4 places a call back 5 over the secondary network to the mobile phone 1. In addition, the manager 4 places a call 6 over the secondary network to the target telephone 14. It should be noted, that the called back telephone does not necessarily have to be the telephone that originated the session; any telephone can be called after the session originates. The call back number can be the correct telephone number or the virtual telephone number of the original user. It is even possible that the originating telephone is not included in the conference at all. It is assumed that the secondary network has an interface into at least one cellular network so that mobile telephones can be connected as well as fixed telephones. While this interface can normally be into a cellular voice network, it could also be a voice over IP or other packetized voice service that any of the mobile telephone (or any telephone participating in the call) can receive. Thus, the target telephone can be either fixed or mobile. The manager 4 then connects the two calls in a manner similar to conferencing. In particular embodiments of the present invention, a user could set up a conference call by simply supplying multiple target numbers in the call setup request. It should also be noted, that while in the preferred embodiment, the originating telephone is mobile, the originating telephone can be any type of telephone using any type of service including fixed telephones and voice over IP or other internet telephones.

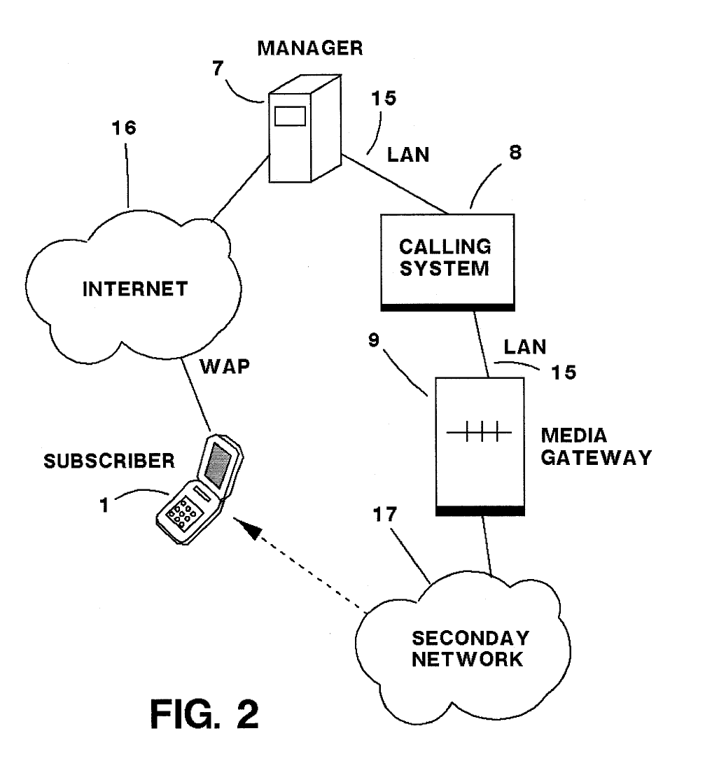

FIG. 2 shows a minimal system that a manager station can use to setup calls according to the present invention. A call control server 7 interfaces with the internet (or other data service) 16 and receives data packets. In particular, the call control server 7 receives call setup requests from a user telephone 1. In a particular embodiment of the invention, packets originate at the calling mobile telephone and are transmitted into the internet using a mobile data service such as GPRS. A proprietary protocol is typically used to achieve call request and setup; however, any protocol can be used. Any method of transmitting data from a mobile telephone to the control server is within the scope of the present invention. When the internet is used, messages are normally IP encapsulated and can use TCP or UDP.

The call control server 7 can be connected via a LAN 15 or other data connection to a calling system 8. The calling system 8 can contain IP PBX units or any other type of PBX-like unit, switch or conferencing unit. A preferred type of PBX unit can be an OM100 IP-PBX manufactured by New Rock Technologies, Inc. of China. The LAN 15 can also be tied to a media gateway 9 which converts packet voice data to TDM, SIP, VoIP or other format compatible with the secondary network 17 along with signaling information. The call control server 7 causes the two outgoing calls to be placed over the secondary network using standard call signaling techniques known in the art. Voice data from each of the calls can be converted to packet and switched (connected) by the IP PBX units in the calling system 8 or can be directly coupled using methods known in the art. This is typically handled in a manner similar to a standard conference call. Any PBX type unit, voice transport or method of placing and connecting the calls is within the scope of the present invention. In particular, the gateway 9 should be able to interface on an IP or other type of LAN 15 on one side and into a particular secondary network 17 on the other side. The link into the secondary network should be able to handle an analog line with requirements such as Loop Start, Ground Start, E&M, etc., digital TDM or other digital interface such as DS-1, E1 or International TDM systems, number relay such as ISDN-PRI, out of band signaling such as CCITT 7 Common Channel Signaling, ISUP, and a basic IP agreement such as SIP, H.323, H.248, MGCP or others.

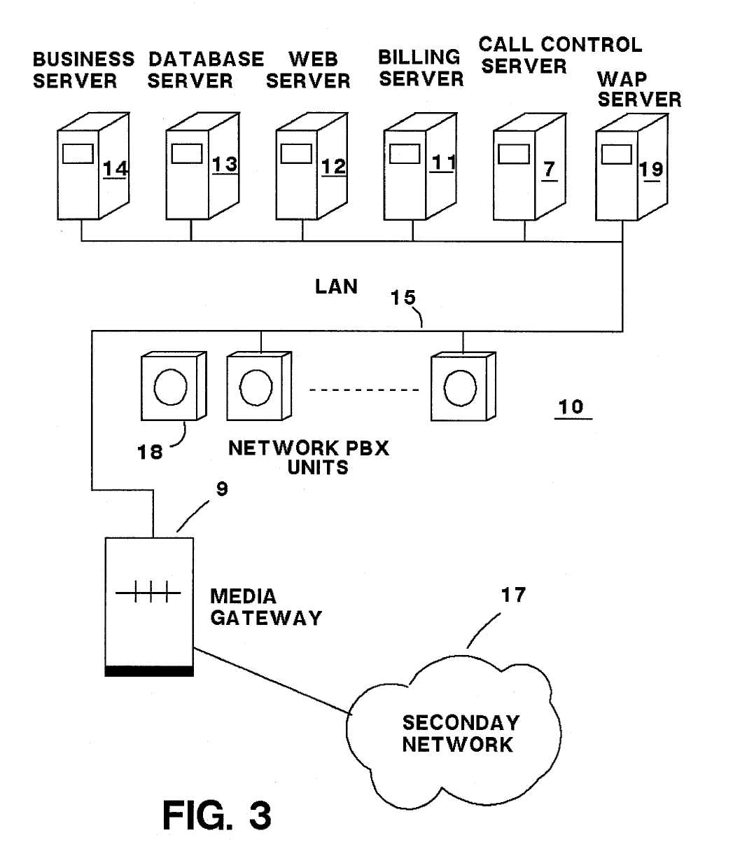

FIG. 3 shows an overall system diagram of a system that can provide the service of the present invention to a large number of subscribers. A central control sub-system includes several servers which can be any type of server, PC, CPU or computer known in the art. Standard server computers are preferred. A central control system 10 can include a WAP server 19 used to provide a web page for WAP browsers on users' mobile telephones. This WAP server can receive the incoming call setup information over the internet, a call control server 7 as previously described that receives call setup information from the WAP server 19 or directly from the mobile telephone using a specially downloaded software application. The control system 10 can also contain a billing server 11 to bill subscribers (at a lower rate than mobile toll calls), and a web server 12 that can allow subscribers to access, pay and control their accounts via the internet. The web server and the WAP server can be combined into a single server. The web server typically communicates account information and receives account replenishment using secure techniques known in the art. The web server 12 can also provide initial sign-up processing and control the download of mobile phone software to a new user's mobile telephone (or to an old user with a new mobile phone A). A data base server 13 can manage all data bases needed for the service including a subscriber data base. An optional dialing server 19 can be used to place calls. Finally, a business administration server 14 can provider overall business management and coordination for the system by tying all the other servers together. A LAN or other network 15 ties all of these servers together, and in particular ties the call control server 7 to a set of PBX units 18 and at least one media gateway 9 into a secondary network 17. As is well-known in the art, several of the various servers described above can be combined and run on the same physical server platform.

FIG. 3 also shows an expanded calling system with multiple PBX or switch units 18. The number of PBX units needed depends on the number of subscribers and can be chosen by statistical techniques known in the art. Since the PBX units generally handle only voice in particular embodiments of the invention, voice statistics can be used. However, in other embodiments, data, both narrow and wideband, may also be switched and connected using various techniques known in the art.

In addition to using the originator's actual telephone number, the system of the present invention supports the use of virtual telephone numbers. Virtual telephone numbers are numbers that can be owned and can follow a particular individual. The call back and the caller ID number seen by recipients can be the virtual number. In addition, the called telephone number and any other telephone numbers involved in the transaction can be virtual telephone numbers.

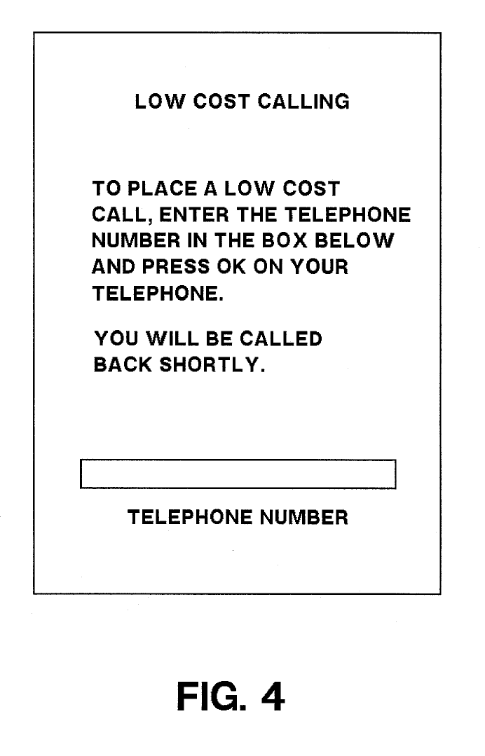

FIG. 4 shows a typical menu that can be displayed on a mobile screen. This menu can be the result of the software download to the mobile handset running on an application processor in the mobile telephone, or it can be a browser screen on the telephone's WAP browser The call-out activity of the invention can be activated by pressing a particular key indicating a desire on the part of the user to place an outgoing toll call. The menu shown in FIG. 4 only requests entry of the called telephone number or numbers. These can be taken from an internal address book in some embodiments of the invention. After the target (called) telephone number is entered, the user can key an “Enter” or “Go” key to initiate call setup. At this point, a message can appear telling the user that its telephone will very shortly be called. When the mobile call from the master station comes in, it can be answered in the normal manner. The menu shown in FIG. 4 is simply an example. Any type or family of menus is within the scope of the present invention.

The general functioning of embodiments of the present invention are as follows: The call control server 7 receives a message sent by a mobile user either directly or via the internet with a WAP browser that includes the account number, password, mobile telephone number and the called number. The call control server 7 queries the database on the database server 13 to verify the account number, check the account balance to make sure the user has the necessary funds to make the call. After verification, the call control server 7 sends the caller number and the called number to the dialing server 19, and sends a notice in the form of a message to the user. The call control server 7 can also calculate the number of minutes the user can talk based on the rate and amount of funds in the user's account. When the dialing server 19 receives a request from the call control server 7, it generally initiates calls through its interface to the secondary network. Normally, connection is first made to the caller and then to the called number. Once, the call is complete, and a total call time is computed, the billing server 11 can deduct the cost of the call from the user's account. The web server 12 can provide detailed call records to the user of each call, account balance and statistical data.

It should be noted that all of the functions described can be combined and run on a single server or a different mix of servers. The particular examples discussed here represent only a particular embodiment of the invention. Any number or combination of servers is within the scope of the present invention.

Several descriptions and illustrations have been provided to aid in understanding the present invention. One skilled in the art will realize that numerous changes and variations are possible without departing from the spirit of the invention. Each of these changes and variations is within the scope of the present invention.

What is claimed is:

1. A method of placing a mobile telephone call over a secondary network comprising:
causing software on a mobile telephone to transmit a target telephone number from said mobile telephone to a first remote server;
calling back said mobile telephone from a second remote server using said secondary network to create a first telephone call;
calling said target telephone from said second remote server to create a second telephone call;
connecting said first telephone call to said second telephone call so that said cellular telephone can communicate with said target telephone.

2. The method of claim 1 wherein said first server and said second server are the same server.

3. The method of claim 1 wherein said software module on said cellular telephone transmits said target number to said first remote server via the internet.

4. The method of claim 3 wherein said mobile telephone transmits using GPRS.

5. The method of claim 3 where a WAP browser is used on the mobile telephone.

6. The method of claim 1 wherein a fee is charged for placing said mobile telephone call.

7. The method of claim 1 wherein an account is maintained for a user of said mobile telephone.

8. A system for placing calls for mobile subscribers using a secondary network comprising:
a call server computer that receives call requests from mobile telephones via the internet, wherein a call request contains at least a target telephone number;
a network switching device capable of interconnecting at least two telephone calls so that end users on each call can communicate with each other;
a secondary network gateway capable of placing calls on said secondary network connecting said network switching device into said secondary network;
a data interface connecting said network switching device to said server;
wherein, upon receiving a call request from a particular mobile telephone, said call server calls said particular mobile telephone back over said secondary network and calls said target telephone over said secondary network, said server then causing said network switching device to interconnect said telephones, whereby users at both telephones can communicate.

9. The system for placing calls of claim 8 further comprising a billing server that computes and bills calls to accounts associated with said mobile telephones.

10. The system for placing calls of claim 8 wherein said server receives call requests using GPRS.

11. The system for placing calls of claim 8 wherein said mobile telephones execute downloaded software for communicating with said server.

12. The system for placing calls of claim 8 further comprising at least one database containing account information for said mobile telephones.

13. The system for placing calls of claim 8 wherein said secondary network is a PSTN.

14. The system for placing calls of claim 8 wherein said mobile telephones can use virtual telephone numbers.

15. The system for placing calls of claim 8 wherein said mobile telephones can communicate with said call server using WAP.

16. A system for placing calls from a user mobile telephone to another telephone comprising a WAP server that receives an originating telephone number and a target telephone number from a mobile user; a call control server connected to said WAP server that calls back a particular mobile telephone over a secondary network using either said mobile telephone's correct telephone number or a virtual telephone number and that calls said target telephone number over said secondary network; a network switch that connects said particular mobile telephone to said target telephone to create a telephone call; a billing server that bills a particular user account for said telephone call.

17. The system of claim 16 further comprising a web server for establishing and maintaining said particular user account.

18. The system of claim 16 further comprising a database server for storing said particular user account.

19. The system of claim 18 wherein said database server further stores telephone numbers including virtual telephone numbers.
